(19) United States
(12) Patent Application Publication
(10) Pub. No.: US 2025/0280162 A1
(43) Pub. Date: Sep. 4, 2025

(54) TEMPORAL CLUSTER-BASED TARGETING

(71) Applicant: INTERNATIONAL BUSINESS MACHINES CORPORATION, Armonk, NY (US)

(72) Inventors: Logan BAILEY, Atlanta, GA (US); Suman PATRA, West Bengal (IN); Jeremy R. FOX, Georgetown, TX (US); Zachary A. SILVERSTEIN, Georgetown, TX (US)

(21) Appl. No.: 18/594,318

(22) Filed: Mar. 4, 2024

(51) Int. Cl. H04N 21/24; H04N 21/25; H04N 21/2668

(52) U.S. Cl. CPC H04N 21/2407; H04N 21/251; H04N 21/2668

(57) ABSTRACT

Computer implemented methods, systems, and computer program products include program code executing on a processor(s) obtains digital content and determines a target group (cluster) for the digital content. The processor(s) determine historical usage metrics on a social media platform for users in the cluster and utilize the historical usage metrics to determine a threshold value for identifying an optimized release time for the digital content to the cluster. The processors determine that current usage metrics exceed the threshold value, by monitoring, in real-time, one or more users in the cluster to obtain usage data, calculating, based on the usage data, the current usage metrics, comparing the current usage metrics to the threshold value, and based on determining that the current usage metrics exceed the threshold value at a given time, transmitting the digital content to the clutter via the social media platform.

### BACKGROUND

The present invention relates generally to the field of data machine learning and in particular, to a method for optimizing content and content-timing for serving digital media.

Appealing to and connecting with the right audience at the right time provides commercial value. Whether it's for content presentation, user to user engagement, or other interaction, the opportunity to provide content to a user at a perceived “right time” increases the likelihood of content efficacy. Visual placement (on social media platforms) of electronic media and direct notifications to users likely to interact with the media and to further promote the media at the time the users received the content enables media producers to benefit from these promotions. Optimizing the users who receive specific content, when they receive the content, and how they receive the content, are all factors that can drive the success of the specific content, which can include, but is not limited to encouraging users to attend events such as workshops, and/or to utilize certain products and/or services.

Artificial intelligence (AI) refers to intelligence exhibited by machines. Artificial intelligence (AI) research includes search and mathematical optimization, neural networks, and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

Natural language understanding (NLU) uses deep learning to extract meaning and metadata from unstructured text data. For example, NLU can be used to extract categories, classification, entities, keywords, sentiment, emotion, relations and/or syntax from text. NLU capabilities can be implemented as a machine learning system that can include a neural network (NN). NLU technologies can utilize supervised, semi-supervised, or unsupervised deep learning through a single-or multi-layer NN to classify data. The deep learning capabilities use the NN to identify and weight connections between data points. The use of deep learning, including in NLU, is understood as a form of artificial intelligence. A subset of NLU is natural language processing (NLP). NLP is a subfield of AI and computer science that focuses on the tokenization of data and specifically, the parsing of human language, whether spoken or text, into its elemental pieces.

### SUMMARY

Shortcomings of the prior art are overcome, and additional advantages are provided through the provision of a computer-implemented method for temporal targeted digital content transmission. The method can include: obtaining, by one or more processors, digital content; determining, by the one or more processors, a target group for the digital content, wherein the target group comprises a cluster; determining, by the one or more processors, historical usage metrics on a digital content platform for users in the cluster; utilizing, by the one or more processors, the historical usage metrics to determine a threshold value for identifying an optimized release time for the digital content to the cluster; determining, by the one or more processors, that current usage metrics exceed the threshold value, the determining, comprising: monitoring, by the one or more processors, in real-time, one or more users in the cluster to obtain usage data; calculating, by the one or more processors, based on the usage data, the current usage metrics; comparing, by the one or more processors, the current usage metrics to the threshold value; and based on determining that the current usage metrics exceed the threshold value at a given time, transmitting the digital content to the clutter via the digital content platform.

Computer systems and computer program products relating to one or more aspects are also described and may be claimed herein. Further, services relating to one or more aspects are also described and may be claimed herein.

Additional aspects of the present disclosure are directed to systems and computer program products configured to perform the methods described above. Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present disclosure;

FIG. 2 is a workflow that provides an overview of various aspects performed by the program code (executing on one or more processors) in some embodiments of the present disclosure;

FIG. 3 is a workflow that provides an overview of various aspects performed by the program code (executing on one or more processors) in some embodiments of the present disclosure; and

FIG. 4 is one example of a machine learning training system that can be utilized to perform various aspects performed by the program code (executing on one or more processors) in some embodiments of the present disclosure.

### DETAILED DESCRIPTION

The examples herein provide an approach for maximizing commercial interactions and relevance in a real-time setting. The examples herein include computer-implemented methods, computer program products, and computer systems, where program code, executed on one or more processors, generates and tunes machine learning algorithms and applies these algorithms to determine targets and/or targeted timeframes for providing digital content based on determining that the targets and the targeted timeframes will produce an optimized response to the digital content at a predicted time. In some examples, the program code obtains digital content from a digital content creator. The program code can analyze the digital content to identify a target group of users on a social media platform or digital content platform. For illustrative purposes, a social media platform is used throughout as a non-limiting example of a digital media platform upon which program code in the examples herein can release digital content. The program code can determine historical usage metrics for respective users in the target group of users on the social media platform. Based on determining that one or more current usage metrics for a given user in the target group of users on the social media platform exceeds a predetermined threshold, in some examples, the program code can transmit the digital content to the given user via the social media platform. In some examples, the program code determines or otherwise obtains scores for the users based on current usage metrics and determines or otherwise obtains an aggregate for the group. Then, based on the aggregate score exceeding a predetermined threshold, the program code transmits the digital content to the given user. (Hence, the timing for when the program code transmits digital content can be related to the real-time activity of one or more users in a group). The current usage metrics utilized by the program code can vary and can include, but are not limited to: (i) digital content platform interactivity metrics associated with a user, (ii) social media posts by a user, (iii) blogs, technical reports, and/or other publications written by a user, (iv) status indicators (active/away) associated with a user, and/or (v) particular content being viewed by a user and interaction data between a user and the digital content creator.

As will be discussed in greater detail herein, program code in various examples clusters users into groups and provides specific media content to these groups based on (pre- determined) thresholds being met by an aggregate of the group. The words group and cluster are used interchangeably herein. The program code designates a cluster that includes certain users and obtains digital content from a content creator. The program code, in some examples, releases the digital content (which the program code can queue) when the program code determines that a threshold of activity within that cluster has been met (and/or that a given threshold event has occurred). This threshold of activity can include, but is not limited to, the program code determining that a given individual in the cluster is present (e.g., the user is active on the social media platform upon which the program code will release he digital content). This given individual can be one of a group of users that the program code is targeting. In other examples, the program code can release the digital content to a cluster based on other factors related to aggregate activity as well as activity of individuals within the group (e.g., a given percentage of individuals in the group). In some examples, the program code can utilize the content and/or context of the digital content to determine a target audience and a minimum threshold (e.g., of activity) for providing the content to the audience.

The examples described herein are inextricably tied to computing and are directed to a practical application. The examples herein address an issue that is inextricably tied to computing with an approach that utilizes aspects that are inextricably tied to computing. Program code executed by one or more processors in the examples herein optimizes user interactions with digital content on social media platforms, which is a practical application that is unique to computing. To address this issue, program code in the examples herein employs aspects that are inextricably tied to computing. For example, program code in various examples performs an analysis of real-time cluster activity. As such, the program code herein develops and applies (e.g., machine learning) algorithms capable of analyzing user cluster activities in real-time to handle high-velocity data streams to capture live user interactions. The program code also implements (and can train) algorithms to predict optimal content release times based on user cluster activity patterns. To identify these release times, the program code can dynamically set thresholds for content release based on live user activities.

Because the examples herein are inextricably tied to computing, the program code described herein can be integrated with various data sources (ensuring compatibility with multiple social media and content platforms to access real-time user activity data). The program code can aggregate and process data from diverse sources, including application programming interfaces (APIs), server-side feeds, and browser-based inputs. Certain examples herein repurpose tools that are inextricably linked to computing, such as network analysis tools, to address a practical application of understanding the relationships and influence dynamics within user clusters. Based on analyzing network activity, program code in examples herein develops metrics to quantify network influence and the potential impact of content on specific user groups.

The examples herein are also inextricably tied to computing based on utilizing machine learning to continuously update and refine models to improve accuracy and efficiency. The examples herein can develop and train machine learning models, such as recurrent neural networks (RNNs) and/or convolutional neural network (CNNs), to predict user interaction likelihood and determine the impact of potential message postings (and/or other digital content on social media), including temporal aspects of these postings. The program code continuously updates and refines these models to improve accuracy and efficiency.

Neural networks, which are utilized in certain of the examples herein, refer to a biologically inspired programming paradigm which enables a computer to learn from observational data. This learning is referred to as deep learning, which is a set of techniques for learning in neural networks. Neural networks, including modular neural networks, are capable of pattern recognition with speed, accuracy, and efficiency, in situations where data sets are multiple and expansive, including across a distributed network of the technical environment. Modern neural networks are non-linear statistical data modeling tools. They are usually used to model complex relationships between inputs and outputs or to identify patterns in data (i.e., neural networks are non-linear statistical data modeling or decision-making tools). In general, program code utilizing neural networks can model complex relationships between inputs and outputs and identify patterns in data. Because of the speed and efficiency of neural networks, especially when parsing multiple complex data sets, neural networks and deep learning provide solutions to many problems in image recognition, speech recognition, and natural language processing. Neural networks can model complex relationships between inputs and outputs to identify patterns in data, including in images, for classification. In the examples herein, the program code can utilize CNNs and/or RNNs to predict user interaction likelihood and determine the impact of digital content on various users, at various times. Because the program code utilizes live activities of users and groups of users to generate and update a model to make these predictions, depending on the type of activities that the user is engaged in (e.g., the type of content the user is posting on social media platforms), the program code can utilize one or more of these neural networks to predict user interaction likelihood and determine the impact of potential message postings (and/or other digital content on social media).

In certain embodiments of the present invention the program code utilizes a CNN. A CNN is a class of neural network that utilizes feed-forward artificial neural networks and are most commonly applied to analyzing visual imagery. Activity of users on social networks includes posting and interacting with images. CNNs are so named because they utilize convolutional layers that apply a convolution operation (a mathematical operation on two functions to produce a third function that expresses how the shape of one is modified by the other) to the input, passing the result to the next layer. The convolution emulates the response of an individual neuron to visual stimuli. Each convolutional neuron processes data only for its receptive field. It is generally not practical to utilize general (i.e., fully connected feedforward) neural networks to process data rich objects, such as images, as very high number of neurons would be necessary, due to the very large input sizes associated with larger filed. Utilizing a CNN addresses this issue as it reduces the number of free parameters, allowing the network to be deeper with fewer parameters, as regardless of image size, the CNN can utilize a consistent number of learnable parameters because CNNs fine-tune large amounts of parameters and massive pre-labeled datasets to support a learning process. CNNs resolve the vanishing or exploding gradients problem in training traditional multi-layer neural networks, with many layers, by using backpropagation. Thus, CNNs can be utilized in large-scale recognition systems, giving state-of-the-art results in segmentation, object detection, and object retrieval.

In certain embodiments of the present invention the program code utilizes an RNN. An RNN is a class of NN where connections between units form a directed cycle in order to exhibit dynamic temporal behavior. Unlike feedforward NNs, RNNs can use their internal memory to process arbitrary sequences of inputs. For this reason, current applications of RNNs include unsegmented data recognition, connected handwriting recognition, and speech recognition. As activity associated with social media platforms can include oral content (e.g., speech), as well as textual content, including handwritten content, the program code cam utilize an RNN to perform analyses that include this content.

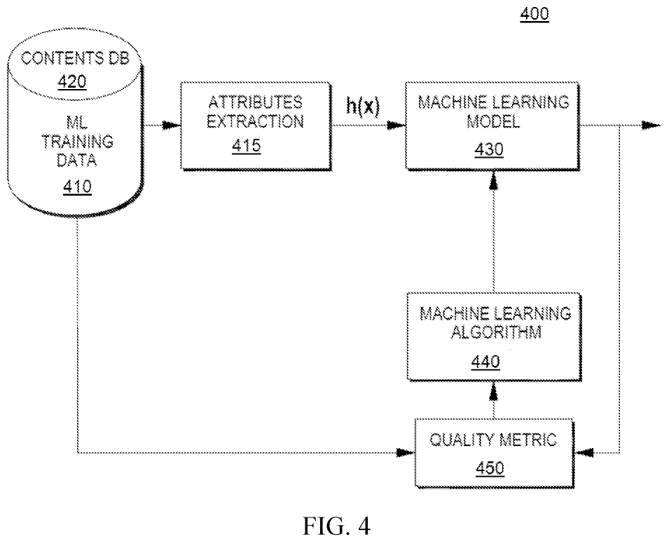

A deep learning model can refer to a type of classifier. The program code can implement a deep learning model in various forms such as by a neural network (e.g., a CNN, an RNN). In some examples, a deep learning mode includes multiple layers, each layer comprising multiple processing nodes. In some examples, the layers process in sequence, with nodes of layers closer to the model input layer processing before nodes of layers closer to the model output. Thus, layers feed to the next. Interior nodes are often “hidden” in the sense that their input and output values are not visible outside the model. In these examples, the program code can utilize NNs to classify users into clusters dynamically based on real-time activities of the users. FIG. 4, which will be discussed later herein, illustrates a classifier 400 that can be utilized in some of the examples herein.

Certain of the examples herein are also inextricably tied to computing and directed to a practical application because they utilize robust computer architectures to address user experience and processing speed, and data security and integrity issues. As will be discussed herein, various examples include a robust and scalable backend capable of processing large volumes of data without significant latency. Optimizing data processing for speed and accuracy enables the program code to provide timely content release suggestions. Some examples herein increase usability by including a user interface (e.g., an API) for audience targeting. Some examples include the program code generating a user-friendly interface (e.g., a graphical user interface (GUI)) for users to designate target audiences, including individuals, groups, or dynamic cohorts. This interface can integrate seamlessly with the aforementioned backend processing and data analysis components or aspects. Meanwhile, an ongoing issue with software and hardware that is relevant to social media platforms is user privacy and data security. Examples herein comply with privacy laws and regulations, particularly when handling user data. The examples can include robust security measures to protect user data from unauthorized accesses or breaches.

In addition to being inextricably tied to computing and being directed to a practical application, the examples herein provide significantly more than existing approaches to optimizing the targeting of users of social media with relevant digital content. Aspects that provide significantly more include (but are not limited to): 1) utilizing (dynamic) user activity in real-time to target users; and 2) determining an optimized timing for content delivery to targeted users. Unlike existing approaches, in the examples herein, the program code leverages both live user activity and real-time interaction data to target release of content. The combination of live user activity and historical interaction data provides increased targeting accuracy over existing approaches of providing content based on predetermined user preferences. The dynamic, real-time approach to content targeting and release described herein maximizes commercial engagement and interaction. An additional advantage of the examples herein over existing content-targeting approaches is the emphasis on timing. Specifically, in accordance with the temporal aspects of some examples, the program code releases content to targeted users based on live user engagement within specific clusters or groups. Thus, in the examples herein, the program code executing on one or more processors can leveraging real-time, dynamic user activity for content targeting and release, rather than the static demographic and historical data reliance utilized in existing approaches. As noted above, the examples herein also include program code executing on one or more processors that dynamically targets content release based on live user engagement and interaction patterns within specific user clusters on social media platforms, rather than relying on pre-identified audience information from non-social sources like existing approaches. The data utilized by the program code both to target users for digital content as well as to time the delivery is based on the program code learning (including based on generating and tuning machine learning algorithms) current user behaviors and interactions, which is distinct from the static data-driven targeting approach utilized in existing approaches. Aspects of the examples herein renders the examples scalable and provide for efficient data processing, which is an advantage over existing approaches.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

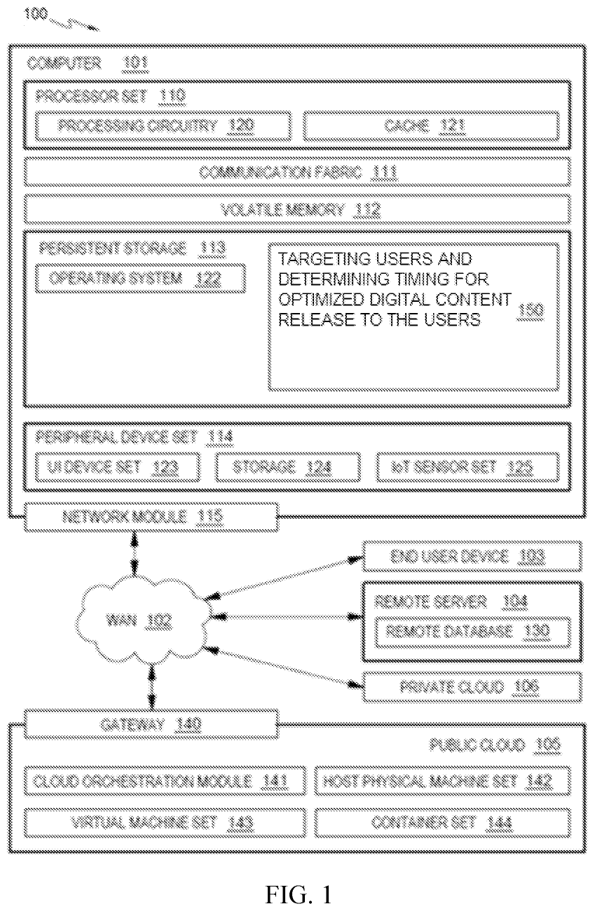

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as a code block for targeting users and determining timing for optimized digital content release to the users 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

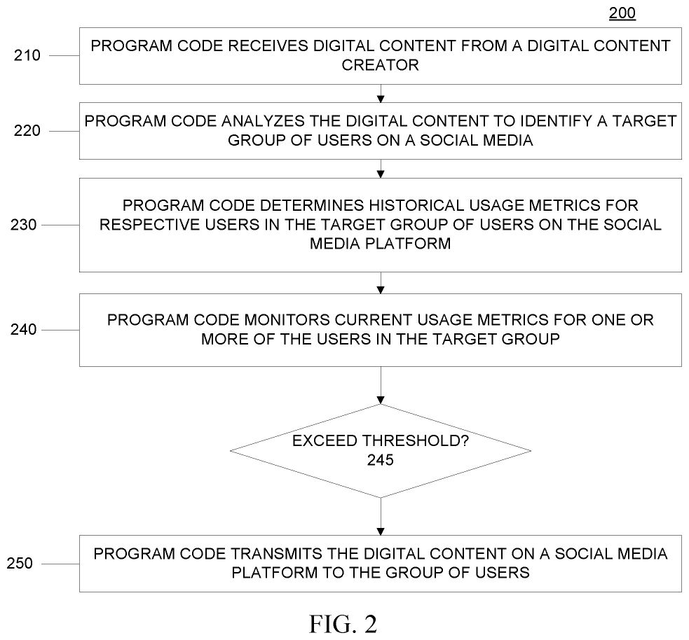

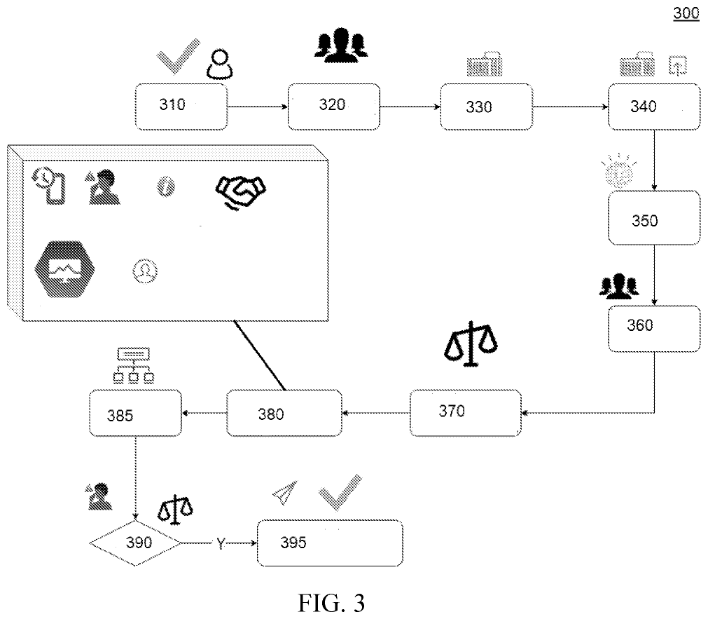

FIGS. 2-3 are workflows 200 300 that illustrates various aspects of some examples described herein where program code executing on one or more processors maximizes commercial interactions and relevance for users of social media platforms in a real-time setting. FIG. 2 is a more general workflow 200 while FIG. 3 is a workflow 300 with more details that can be integrated into various examples. Both workflow 200 300 are non-limiting examples and provided for illustrative purposes.

FIG. 2 illustrates a workflow 200 where program code executing on one or more processors performs targeted digital content actions. The program code receives digital content from a digital content creator (210). The program code analyzes the digital content to identify a target group of users on a social media (220). The program code determines historical usage metrics for respective users in the target group of users on the social media platform (230). The program code monitors current usage metrics for one or more of the users in the target group (240). The usage metrics can include, but are not limited to: (i) digital content platform interactivity metrics associated with a user, (ii) social media posts by a user, (iii) blogs, technical reports, and other publications written by a user, (iv) status indicators (active/away) associated with a user, and/or (v) particular content being viewed by a user, and interactions data between a user and the digital content creator. Based on one or more of the historical usage metrics or the current usage metrics for one or more of the users in the target group exceeding a predetermined threshold at a given time (245), the program code transmits the digital content on a social media platform to the group of users at the given time (250). In some examples, the program code transmits the content after the current usage metrics for one user in the group exceeds the pre-determined threshold. In other examples, based on the program code monitoring current usage metrics for the users, the program code calculates scores associated with these current usage metrics. The program code can then transmit the social media when the score of a given user exceeds a threshold and/or when an aggregate score of the group exceeds the threshold. In other examples, the program code releases the content to the group when a pre-determined number of users have (engagement) scores that exceed the threshold.

The workflow 300 of FIG. 3 includes illustrations of portions of the technical environment in which certain of the examples herein can be implemented. In some embodiments, program code executing on one or more processors as well as the one or more processors can reside on a content distribution platform focused on content release and targeting. This content distribution platform can reside partially on a social media platform, can be browser-based and integrate with server side APIs, and/or can reside completely on a server-side. These are just some non-limiting examples of implementations, provided for illustrative purposes, only.

In the example illustrated by FIG. 3, program code executing on one or more processors obtains a notification or otherwise determines that a given user who created content has opted into participating in a targeted content system (310). Providing users with an option to opt in preserves user security and privacy as users can control their participation and what data is provided to the program code (directly and/or indirectly). Program code obtains a notification or otherwise determines that participants have opted in (320). Participants can be understood as users who could receive content. The program code provides users with a GUI, which can be an API, to enable a user to generate digital content (330). The program code obtains the digital content the user created utilizing the GUI (340). In some examples, the program code can obtain the content based on the user uploading the digital content to a repository that the program code can access. Upon obtaining the digital content, the program code processes the digital content to classify it as being relevant to a target audience (350). This pre-processing can include, but is not limited to, applying NLU and NLP and a neural network to parse the language in the digital content, whether spoken or text, and tokenize it into its elemental pieces.

In some examples, the program code can apply an NLP model to process the digital content and classify it as being relevant to a given target audience (350). The NLP model can be based on a transformer model (e.g., IBM Cognos® Transformer), which is a metadata modeling tool that can be used to create cognitive decision-making blocks that can be utilized by machine learning algorithms. In examples herein, the NLP model can be provided with data from social media networks data collected, for example, by a crawler via APIs and RPAs. One or more embodiments of the present disclosure can utilize IBM Watson® NLP. Cognos and Watson are trademarks or registered trademarks of International Business Machines Corporation in at least one jurisdiction. The program code in the examples herein can utilize IBM Watson® NLP or other NLP algorithms or models to analyze text (e.g., the text of the order and the aforementioned digital content) to infer certain characteristics that would suggest a classification for the digital content as being relevant to a given cluster of users (based on historical data) through syntax analysis by utilizing pretrained and custom models. The program code in embodiments of the present disclosure can identify patterns in text that target user interest and can weight these various patterns to indicate a likelihood (e.g., on a pre-defined scale) a given user or group of users (e.g., based on user characteristics such as demographics) will interact with the digital content, based, for example, on historical data. Thus, the program code analyzes the content of the digital content and based on this content, determines a target audience for the digital content.

In some example, the users can designate a specific audience for targeting and the program code can utilize the characteristics of this defined audience when identifying a cluster of users to receive digital content. An audience can, for example, be an individual or group of actual people (who have opted in), a cohort or targeted group based on a marketing subset, and/or a dynamic group based on followers, attendees, etc.

Returning to FIG. 3, based on classifying the digital content, the program code identifies users (who have opted in) as being part of a target audience for the digital content (360). As noted earlier, the program code determines when to transmit digital content to users in a target audience based on exceeding a pre-determined threshold. Thus, in this example, once the program code classifies the digital content as being relevant to a given target audience and identifies the users (e.g., participants) in the target audience, the program code determines or obtains the pre-determined threshold (370). In examples herein where program code determines the pre-determined threshold, the program code executing on one or more processors, determines the threshold based on predicting optimal content release times based on user cluster activity patterns. To this end, the program code analyzes user cluster activities in real-time to handle high-velocity data streams to capture live user interactions. The program code utilizes the live user interactions to train machine learning algorithms to generate a threshold. The threshold is a prediction of an optimal content release time.

In some example, the program code monitors activity of users in the cluster to determine a user score (that can be compared to the threshold individual and/or as part of an aggregate) (380). The threshold can be a threshold of execution for activity based on the presence of targeted individuals, based on a level of live activity of users with the social media platform (as transmitting content when a user is active is arguably more effective). The type of threshold utilized in these examples can vary and can include a simple threshold (e.g., above average), a result of applying a weighted algorithm based on actions a user takes, and/or a predictive value of an individual's action rate abstracted across many individuals. In some examples, the threshold (e.g., a relevant degree of activity versus inactivity of one or more users) can be encoded in an alert. In some examples, the program code can measure a distance between a degree of relevance and a user's level of action.

In monitoring the user activity, the program code can access each user's activity history to determine a per user score in the cluster (or cohort) for iterative action. To score the user, the program code can access, for example, the user's real-time activity on the platform, the user's historical activity on the platform, the interests of the user, metadata metrics relevant to the user, a user state, and/or user target rankings. The program code can monitor content platform activity metrics of the target audience to gauge a historical action rate, including but not limited to interactivity metrics, social media posts by the user, blogs, technical reports, and other publications written by the user, active/away information, and/or content user is engaging in. Additionally, the program code can utilize these metrics to derive an RNN and/or CNN model which the program code applies to predict a user's likelihood of a interacting with digital content. As aforementioned, metrics that the program code can utilize to calculate a score for a user can include, but are not limited to, include: (i) digital content platform interactivity metrics associated with a user, (ii) social media posts by a user, (iii) blogs, technical reports, and other publications written by a user, (iv) status indicators (active/away) associated with a user, and (v) the particular content being viewed by a user, and interaction data between a user and the digital content creator.

The program code can transmit the content based on one or more users (including a given percentage of users) in a cluster exceeding a threshold. In this example, the program code determines an aggregate score for the users in the cluster (385). The program code continually updates both the individual scores as well as the aggregate score based on live actions by the users in the cluster. The program code evaluates whether the aggregate score (in this example) has exceeded the pre-determined threshold (390). At a time when the aggregate score exceeds the threshold, the program code transmits (releases) the digital content to the cluster (targeted audience) and tracks interactions of the targeted audience with the content (395). For example, when the cluster (e.g., a cohort of live or present individuals) passes the target threshold of live activity, the program code can release the digital content to impact the user and drive the user towards higher quality (e.g., informational and/or commercial) interactions. In some examples, the threshold is a score that is based on current activity metrics of the user. The program code calculates the scores of the individual user, calculates an aggregate score, and can compare the calculated scores to the threshold.

The program code can utilize the interaction statistics to update the machine learning model and algorithms the program code utilized to classify the digital content for transmission to a target audience (including the definition by the program code of the target audience). In some examples, based on applying the model, the program code determines impacts of the digital content being posted when a user is active in various placements, including but not limited to, at a top of user's feed and/or in a user's notification list. The program code can utilize historical data to train the model to determine a most effective placement for content for a given user and/or cluster. The program code can monitor targeted user activity as available based on platform metrics and APIs. To determine characteristics of the relationship between people in the network model, the program code can apply social network analysis techniques. The program code can determine proximity in the network (e.g., determining if individuals are they directly connected), the extent to which they interact, the recent interaction (based on chat history), and/or whether users are in the same “clique,” and whether “following/follower” relationships exist. The program code can also determine a degree of network influence (e.g., social networking potential) of users. The program code can utilize this information to train the models that identify a cluster for digital content and determine a threshold for release of the content.

As discussed in reference to FIG. 3, program code in some of the examples herein trains algorithms to cluster users and to predict optimal content release times based on user cluster activity patterns. The program code can utilize a CNN and/or an RNN to cluster the users and/or determine criteria for release of digital content to a cluster. FIG. 4 is one example of a machine learning training system 400 (which can also be referred to as a classifier) that can be utilized, in one or more aspects, to perform cognitive analyses of various inputs, including activity history of users and/or live actions on social media platforms by users to cluster users into group and/or to determine a threshold (and hence the timing) for content release based on interactions of users with content on the social media platform. Machine learning (ML) solves problems that are not solved with numerical means alone. In this ML-based example, program code extracts various attributes (415) from historical activity as well as current activity (e.g., user cluster activities in real-time) which serve as ML training data 410. These attributes can be utilized to develop a predictor or classifier function, h(x), also referred to as a hypothesis, which the program code utilizes as a machine learning model 430. A hypothesis in examples where the program code determines a threshold can be understood as parameters defining timing for optimal release of digital content to a cluster. In identifying various resource types, features and/or parameters in the ML training data 410, which can be stored in one or more contents database 420, the program code can utilize various techniques to identify attributes in an embodiment of the present invention. Embodiments of the present invention utilize varying techniques to select attributes (elements, patterns, features, components, etc.), including but not limited to, diffusion mapping, principal component analysis, recursive feature elimination (a brute force approach to selecting attributes), and/or a Random Forest, to select the attributes related to various users and user activities. The program code can utilize a machine learning algorithm 440 to train the machine learning model 430 (e.g., the algorithms utilized by the program code), including providing weights for the conclusions, so that the program code can train the predictor functions that comprise the machine learning model 430. The conclusions can be evaluated by a quality metric 450. By selecting a diverse set of ML training data 410, the program code trains the machine learning model 430 to identify and weight various attributes (e.g., features, patterns, components) that correlate to different scripts and reveal similarities in users, to generate clusters as well as to predict optimal timing for release of digital content to users in a given cluster.

Although various embodiments are described above, these are only examples. For example, reference architectures of many disciplines may be considered, as well as other knowledge-based types of code repositories, etc., may be considered. Many variations are possible.

Disclosed herein are examples of computer-implemented method, computer systems, and computer program products where program code executed on one or more processors obtains digital content. The program code determines a target group for the digital content, where the target group comprises a cluster. The program code determines historical usage metrics on a digital content platform for one or more users in the cluster. The program code utilizes the historical usage metrics to determine a threshold value for identifying an optimized release time for the digital content to the cluster. The program code determines that current usage metrics exceed the threshold value by: monitoring, in real-time, the one or more users in the cluster to obtain usage data, calculating, based on the usage data, the current usage metrics, and comparing the current usage metrics to the threshold value. Based on determining that the current usage metrics exceed the threshold value at a given time, the program code transmits the digital content to the clutter via the digital content platform.

In some examples, the current usage metrics for each user in a cluster are selected from the group consisting of: digital content platform interactivity metrics associated with the user, social media posts by the user, publications written by the user, status indicators associated with the user, content being viewed by the user, and data exchanged between the user and a digital content creator of the digital content.

In some examples, the program code the threshold value comprises a given usage score, and the program code calculating the current usage metrics comprises determining a usage score for each user in the cluster.

In some examples, the given usage score is an aggregate score for all one or more users in the cluster, and the program code transmitting the digital content is based on the aggregate score exceeding the threshold value.

In some examples, the given usage score is a usage score for a first user of the one or more users in the cluster, and the program code transmitting the digital content is based on the usage score for the first user exceeding the threshold value.

In some examples, the program code obtains the digital content from a digital content creator.

In some examples, the program code determining the target group for the digital content comprises: the program code obtaining, with the digital content, metadata indicating the target group.

In some examples, the program code determining the target group for the digital content comprises: the program code analyzing the digital content, to extract attributes relevant to one or more target groups, and the program code applying a machine learning algorithm to classify the digital content, based on the attributes, as being relevant to the target group.

In some examples, the program code trains the machine learning algorithm to classify the digital content, based on the attributes, as being relevant to the target group by: obtaining user attribute data and historical interaction data relevant to the user attribute data, and cognitively analyzing the user attribute data and the historical interaction data to identify the attributes predicting relevance of the digital content to the target group.

In some examples, the program code utilizes the historical usage metrics to determine the threshold value by: analyzing the historical usage metrics to derive attributes of the digital content relevant to responsiveness of the one or more users in the cluster to the digital content, and applying a machine learning algorithm to predict the threshold value based on the attributes of the digital content.

In some examples, the program code trains the machine learning algorithm to predict the threshold value based on the attributes of the digital content by: obtaining live user activity data of the one or more users in the cluster, cognitively analyzing the live user activity data to identify the attributes of the digital content relevant to the responsiveness of the one or more users in the cluster, identifying patterns related to the responsiveness of the one or more users in the cluster, and training the machine learning algorithm, based on the patterns.

In some examples, an attribute of the attributes of the digital content comprises placement of the digital content in a graphical user interface on the digital content platform.

In some examples, an attribute of the attributes of the digital content comprises an alert type for the digital content.

In some examples, the program code applies at least one machine learning algorithm to determine the threshold value for identifying the optimized release time for the digital content to the cluster. Based on the transmitting the digital media, the program code monitors responses by the one or more users in the cluster to the digital content to obtain data related to response timing. The program code updates the at least one machine learning algorithm based on the data related to the response timing.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method for temporal targeted digital content transmission, comprising:
obtaining, by one or more processors, digital content;
determining, by the one or more processors, a target group for the digital content, wherein the target group comprises a cluster;
determining, by the one or more processors, historical usage metrics on a digital content platform for one or more users in the cluster;
utilizing, by the one or more processors, the historical usage metrics to determine a threshold value for identifying an optimized release time for the digital content to the cluster;
determining, by the one or more processors, that current usage metrics exceed the threshold value, the determining that the current usage metrics exceed the threshold value, comprising:
monitoring, by the one or more processors, in real-time, the one or more users in the cluster to obtain usage data;
calculating, by the one or more processors, based on the usage data, the current usage metrics; and
comparing, by the one or more processors, the current usage metrics to the threshold value; and
based on determining that the current usage metrics exceed the threshold value at a given time, transmitting the digital content to the clutter via the digital content platform.

2. The computer-implemented method of claim 1, wherein the current usage metrics for each user in a cluster are selected from the group consisting of: digital content platform interactivity metrics associated with the user, social media posts by the user, publications written by the user, status indicators associated with the user, content being viewed by the user, and data exchanged between the user and a digital content creator of the digital content.

3. The computer-implemented method of claim 1, wherein the threshold value comprises a given usage score, and wherein calculating the current usage metrics comprises determining a usage score for each user in the cluster.

4. The computer-implemented method of claim 3, wherein the given usage score is an aggregate score for all the one or more users in the cluster, and wherein the transmitting is based on the aggregate score exceeding the threshold value.

5. The computer-implemented method of claim 3, wherein the given usage score is a usage score for a first user of the one or more users in the cluster, and wherein the transmitting is based on the usage score for the first user exceeding the threshold value.

6. The computer-implemented method of claim 1, wherein the obtaining is from a digital content creator.

7. The computer-implemented method of claim 6, wherein determining the target group for the digital content comprises:
obtaining, by the one or more processors, with the digital content, metadata indicating the target group.

8. The computer-implemented method of claim 1, wherein determining the target group for the digital content comprises:
analyzing, by the one or more processors, the digital content, to extract attributes relevant to one or more target groups; and
applying, by the one or more processors, a machine learning algorithm to classify the digital content, based on the attributes, as being relevant to the target group.

9. The computer-implemented method of claim 8, further comprising:
training, by the one or more processors, the machine learning algorithm, to classify the digital content, based on the attributes, as being relevant to the target group, the training comprising:
obtaining, by the one or more processors, user attribute data and historical interaction data relevant to the user attribute data; and
cognitively analyzing, by the one or more processors, the user attribute data and the historical interaction data to identify the attributes predicting relevance of the digital content to the target group.

10. The computer-implemented method of claim 1, wherein utilizing the historical usage metrics to determine the threshold value, comprises:
analyzing, by the one or more processors, the historical usage metrics, to derive attributes of the digital content relevant to responsiveness of the one or more users in the cluster to the digital content; and
applying, by the one or more processors, a machine learning algorithm to predict the threshold value based on the attributes of the digital content.

11. The computer-implemented method of claim 10, further comprising:
training, by the one or more processors, the machine learning algorithm, to predict the threshold value based on the attributes of the digital content, the training comprising:
obtaining, by the one or more processors, live user activity data of the one or more users in the cluster;
cognitively analyzing, by the one or more processors, the live user activity data to identify the attributes of the digital content relevant to the responsiveness of the one or more users in the cluster;
identifying, by the one or more processors, patterns related to the responsiveness of the one or more users in the cluster; and
training, by the one or more processors, the machine learning algorithm, based on the patterns.

12. The computer-implemented method of claim 10, wherein an attribute of the attributes of the digital content comprises placement of the digital content in a graphical user interface on the digital content platform.

13. The computer-implemented method of claim 10, wherein an attribute of the attributes of the digital content comprises an alert type for the digital content.

14. The computer-implemented method of claim 1, further comprising:
applying, by the one or more processors, at least one machine learning algorithm, to determine the threshold value for identifying the optimized release time for the digital content to the cluster; and
based on the transmitting, monitoring, by the one or more processors, responses by the one or more users in the cluster to the digital content to obtain data related to response timing; and
updating, by the one or more processors, the at least one machine learning algorithm based on the data related to the response timing.

15. A computer system for temporal targeted digital content transmission, the computer system comprising:
a memory; and
one or more processors in communication with the memory, wherein the computer system is configured to perform a method, said method comprising:
obtaining, by the one or more processors, digital content;
determining, by the one or more processors, a target group for the digital content, wherein the target group comprises a cluster;
determining, by the one or more processors, historical usage metrics on a digital content platform for one or more users in the cluster;
utilizing, by the one or more processors, the historical usage metrics to determine a threshold value for identifying an optimized release time for the digital content to the cluster;
determining, by the one or more processors, that current usage metrics exceed the threshold value, the determining that the current usage metrics exceed the threshold value, comprising:
monitoring, by the one or more processors, in real-time, the one or more users in the cluster to obtain usage data;
calculating, by the one or more processors, based on the usage data, the current usage metrics; and
comparing, by the one or more processors, the current usage metrics to the threshold value; and
based on determining that the current usage metrics exceed the threshold value at a given time, transmitting the digital content to the clutter via the digital content platform.

16. The computer system of claim 15, wherein the current usage metrics for each user in a cluster are selected from the group consisting of: digital content platform interactivity metrics associated with the user, social media posts by the user, publications written by the user, status indicators associated with the user, content being viewed by the user, and data exchanged between the user and a digital content creator of the digital content.

17. The computer system of claim 15, wherein utilizing the historical usage metrics to determine the threshold value, comprises:
analyzing, by the one or more processors, the historical usage metrics, to derive attributes of the digital content relevant to responsiveness of the one or more users in the cluster to the digital content; and
applying, by the one or more processors, a machine learning algorithm to predict the threshold value based on the attributes of the digital content.

18. The computer system of claim 17, further comprising:
training, by the one or more processors, the machine learning algorithm, to predict the threshold value based on the attributes of the digital content, the training comprising:
obtaining, by the one or more processors, live user activity data of one or more users in the cluster;
cognitively analyzing, by the one or more processors, the live user activity data to identify the attributes of the digital content relevant to the responsiveness of the one or more users in the cluster;
identifying, by the one or more processors, patterns related to the responsiveness of the one or more users in the cluster; and
training, by the one or more processors, the machine learning algorithm, based on the patterns.

19. The computer system of claim 15, wherein the threshold value comprises a value selected from the group consisting of: a given usage score, wherein calculating the current usage metrics comprises determining a usage score for each user in the cluster and an aggregate score for all the one or more users in the cluster, wherein the transmitting is based on the aggregate score exceeding the threshold value.

20. A computer program product for temporal targeted digital content transmission, the computer system comprising:
one or more computer readable storage media and program instructions collectively stored on the one or more computer readable storage media readable by at least one processing circuit to:
obtain digital content;
determine a target group for the digital content, wherein the target group comprises a cluster;
determine historical usage metrics on a digital content platform for one or more users in the cluster;
utilize the historical usage metrics to determine a threshold value for identifying an optimized release time for the digital content to the cluster;
determine that current usage metrics exceed the threshold value, comprising:
monitoring, in real-time, the one or more users in the cluster to obtain usage data;
calculating, based on the usage data, the current usage metrics; and
comparing the current usage metrics to the threshold value; and
based on determining that the current usage metrics exceed the threshold value at a given time, transmit the digital content to the clutter via the digital content platform.
